(19) United States
(12) Patent Application Publication
(10) Pub. No.: US 2023/0304340 A1
(43) Pub. Date: Sep. 28, 2023

(54) SLIDING DOOR WITH RECIPROCAL MOTION

(71) Applicant: HNI Technologies Inc., Muscatine, IA (US)

(72) Inventors: Adam Greenfield, Muscatine, IA (US); Sean Oliver, lowa City, IA (US)

(21) Appl. No.: 18/122,869

(22) Filed: Mar. 17, 2023

Related U.S. Application Data
(60) Provisional application No. 63/323,565, filed on Mar. 25, 2022.

(51) Int. Cl. E05D 15/06

(52) U.S. Cl. CPC E05D 15/0652

(57) ABSTRACT

A sliding door assembly including a first sliding door panel having a first width and positioned on a first side, a second sliding door panel having a second width that is greater than the first width of the first sliding door panel and positioned on a second side, at least one support member operable to support the first and second sliding door panels and along which the first and second door panels are operable to translate, and a reciprocal motion member operably coupled to the first sliding door panel and the second sliding door panel, the reciprocal motion member operable to translate one of the first or second sliding door panels when another of the first or second sliding door panels is translated along the at least one support member.

### CROSS-REFERENCE TO RELATED APPLICATION

The present application claims the benefit of and priority to, under 35 U.S.C. § 119(e), U.S. Provisional Application Ser. No. 63/323,565, filed Mar. 25, 2022, titled SLIDING DOOR WITH RECIPROCAL MOTION, which is hereby incorporated by reference in its entirety for all purposes.

### BACKGROUND

Real estate, including office space, is expensive. One of the difficulties that configuring real estate such as office space is providing efficient and effective use of the space while still making that space comfortable and usable. Ingress and egress can be difficult as doors take up a lot of space and limit how that space can be used. Doors are also limiting in how a space can be organized not only from a practical standpoint, but also from an aesthetic standpoint. For example, in an office, a door may prevent where furniture may be placed and for safety concerns such as those addressed in building codes including for disabilities, may further limit how a door is positioned and what types of doors may be implemented. For at least these reasons, improvements to doors are needed for providing efficient, effective, and comfortable use of space.

### SUMMARY

In a first example, a sliding door assembly is provided, including a first sliding door panel having a first width and positioned on a first side; a second sliding door panel having a second width that is greater than the first width of the first sliding door panel and positioned on a second side; at least one support member operable to support the first and second sliding door panels and along which the first and second door panels are operable to translate; and a reciprocal motion member operably coupled to the first sliding door panel and the second sliding door panel, the reciprocal motion member operable to translate one of the first or second sliding door panels when another of the first or second sliding door panels is translated along the at least one support member.

In another example further to the previous example, the sliding door assembly further includes a first fixed panel positioned on the first side and a second fixed panel positioned on the second side, wherein the first sliding door panel is concealed by a profile of the first fixed panel when the sliding door assembly is in an open configuration, and wherein the second sliding door panel is partially concealed by a profile of the first second panel when the sliding door assembly is in the open configuration.

In another example further to the previous examples, the second sliding door panel includes a handle, wherein the handle is exposed when the sliding door assembly is in the open configuration.

In another example further to the previous examples, the first sliding door panel is free of an any handle.

In a second example, a sliding door assembly for limiting and allowing ingress and egress through a doorway defining a lateral midpoint defining a first side and a second side is provided, the sliding door assembly including a first sliding door panel positioned to cover a portion of the first side of the doorway when the sliding door assembly is in a closed configuration and a second sliding door panel positioned to cover the second side and a portion of the first side of the doorway when the sliding door assembly is in the closed configuration.

In another example further to the previous example, the second sliding door panel includes a handle.

In another example further to the previous example, the handle of the second sliding door is positioned on the first side of the doorway when the sliding door assembly is in the closed configuration.

In another example further to the previous example, the first sliding door panel is free of any handle.

In another example further to the previous example, when the sliding door assembly is in an open configuration, the first sliding door panel is positioned outside of a lateral width of the doorway and the second sliding door panel is positioned partially outside of the lateral width of the doorway and partially inside of the lateral width of the doorway.

In another example further to the previous example, the sliding door further includes a reciprocal motion member operably coupled to the first sliding door panel and the second sliding door panel, the reciprocal motion member operable to translate one of the first or second sliding door panels when another of the first or second sliding door panels is translated into or out of the doorway.

In another example further to the previous example, the reciprocal motion member includes a cable and pulley system, the cable being coupled to each of the first and second sliding door panels.

In another example further to the previous example, the reciprocal motion member includes a transmission including gears for transmitting the motion of the first or second sliding door panel to the other.

In another example further to the previous example, the reciprocal motion member includes hydraulics for transmitting motion of the first or second sliding door panel to the other.

In another example further to the previous example, the reciprocal motion member is operable to transmit motion of the first or second sliding door panel to the other in a 1:1 ratio.

In another example further to the previous example, the first and second sliding door panels are pocket doors.

In a third example, a modular wall system is provided including a plurality of wall panels forming a room when installed, the plurality of wall panels defining a doorway for ingress and egress, the doorway including a lateral midpoint defining a first side and a second side and a sliding door assembly including a first sliding door panel positioned to cover a portion of the first side of the doorway when the sliding door assembly is in a closed configuration and a second sliding door panel positioned to cover the second side and a portion of the first side of the doorway when the sliding door assembly is in the closed configuration.

In another example further to the previous example, when the sliding door assembly is in an open configuration, the first sliding door panel is positioned outside of a lateral width of the doorway and the second sliding door panel is positioned partially outside of the lateral width of the doorway and partially inside of the lateral width of the doorway.

In another example further to the previous example, the modular wall system further includes a reciprocal motion member operably coupled to the first sliding door panel and the second sliding door panel, the reciprocal motion member operable to translate one of the first or second sliding door panels when another of the first or second sliding door panels is translated into or out of the doorway.

In another example further to the previous example, the reciprocal motion member includes a cable and pulley system, the cable being coupled to each of the first and second sliding door panels.

In another example further to the previous example, the plurality of wall panels includes a first fixed panel corresponding to the first sliding panel and a second fixed panel corresponding to the second sliding panel, wherein the first sliding panel is positioned fully within a profile of the first fixed panel when in the open configuration and the second sliding panel is positioned partially within a profile of the second fixed panel when in the open configuration.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is an illustration of a modular wall system including an asymmetrical sliding door system according to an embodiment of the present invention.

FIG. 2A is an illustration of the asymmetrical sliding door system of FIG. 1 according to an embodiment of the present invention.

FIG. 2B is an expanded view of a reciprocal motion member of the asymmetrical sliding door system as illustrated in FIG. 2A according to an embodiment of the present invention.

FIG. 3A is an illustration of a side view of the asymmetrical sliding door system of FIG. 1 according to an embodiment of the present invention.

FIG. 3B is an expanded, side view of a reciprocal motion member of the asymmetrical sliding door system as illustrated in FIG. 3A according to an embodiment of the present invention.

It should be understood that the drawings are intended to facilitate understanding of exemplary embodiments of the present invention and are not necessarily to scale.

### DETAILED DESCRIPTION

The following description refers to the accompanying drawings which show specific embodiments. Although specific embodiments are shown and described, it is to be understood that additional or alternative features are employed in other embodiments. The following detailed description is not to be taken in a limiting sense, and the scope of the claimed invention is defined by the appended claims and their equivalents.

It should be understood that like reference numerals are intended to identify the same structural components, elements, portions, or surfaces consistently throughout the several drawing figures, as such components, elements, portions, or surfaces may be further described or explained by the entire written specification, of which this detailed description is an integral part. Unless otherwise indicated, the drawings are intended to be read (for example, cross-hatching, arrangement of parts, proportion, degree, etc.) together with the specification, and are to be considered a portion of the written description.

Generally, office space or other real estate includes a fenestration such as a doorway to allow egress and ingress into the space. Doorways include doors to selectively allow or limit egress and ingress or to provide privacy. A room 10 may be equipped with a sliding door assembly 100 that allows for a doorway 12 to be open or closed. The sliding door assembly 100 allows for optimizing the usable space of the room 10 while providing convenient and simple ingress and egress.

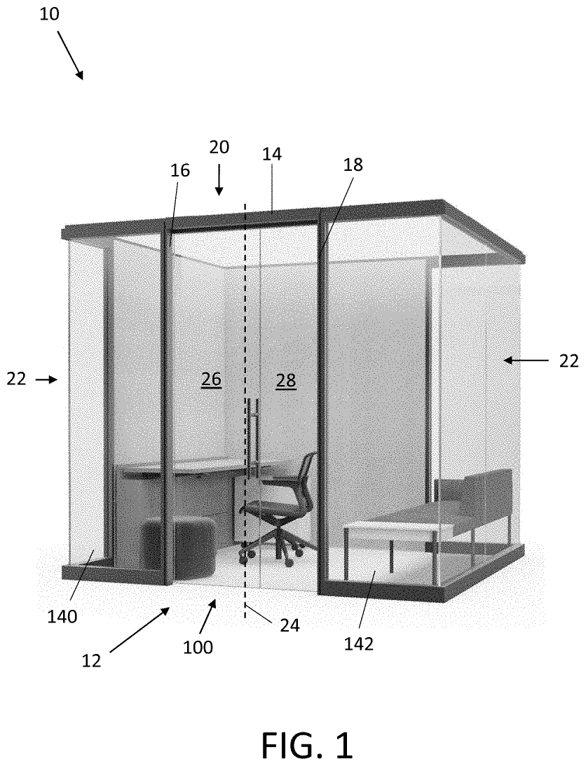

Referring to FIG. 1, a room 10 is illustrated with a doorway 12 for allowing ingress into and egress out of the room 10. The doorway 12 is defined by a door frame 14 that includes a first lateral side 16 and a second lateral side 18. The door frame 14 is positioned on a first wall 20 where the room includes at least one more wall 22 extending from the first wall 20 at positions flanking the doorway 12 at positions laterally spaced from the doorway 12. The doorway 12 defines a midpoint 24 that is laterally between the first lateral side 16 and the second lateral side 18. A first area 26 is defined from the midpoint toward the first lateral side 16 (i.e., including beyond the first lateral side 16), and a second area 28 is defined from the midpoint 24 toward the second lateral side 18 (i.e., including beyond the second lateral side 18). The door frame 14 may be existing or may be installed with the sliding door assembly 100. In some embodiments, the room 10 may be formed by onsite, constructed walls or may be formed by a variety of systems including modular wall and partition systems. The sliding door assembly 100 may be installed in order to selectively cover or uncover the doorway 12. The sliding door assembly 100 is a dual synchronous assembly that implements two sliding panels that are asymmetric in width.

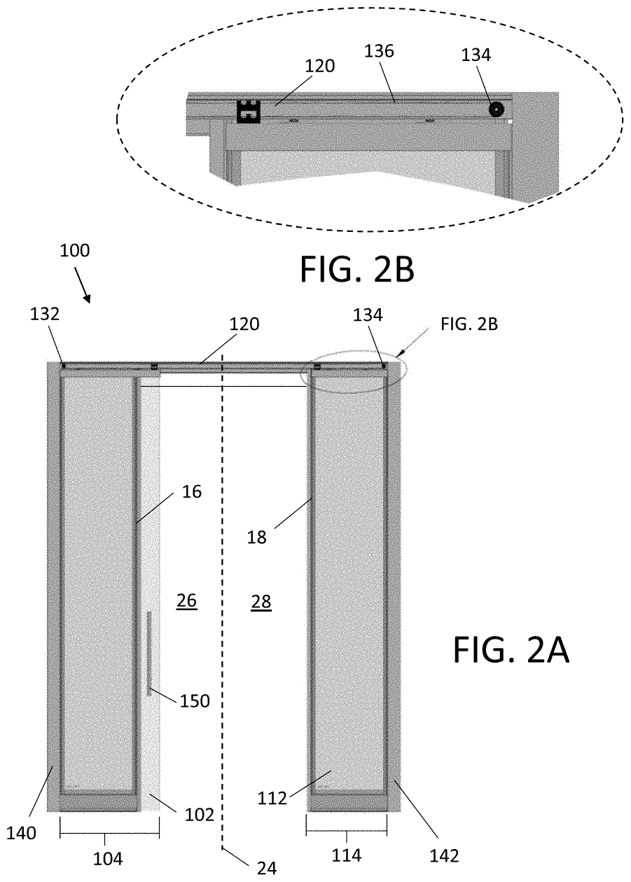

Referring to FIG. 2A, in some embodiments, the sliding door assembly 100 includes a first sliding door panel 102 that has a first width 104 and is positioned on a first side (e.g., corresponding to the first lateral side 16 of the door frame 14) and a second sliding door panel 112 that has a second width 114 that is greater than the first width 104 of the first sliding door panel 102 and is positioned on a second side. The first sliding door panel 102 and the second sliding door panel 112 are supported by a support member 120. The support member 120 may include various parts (e.g., a first portion for supporting the first sliding door panel 102 and a second portion for supporting the second sliding door panel 112) or may be formed as a single part. The support member 120 may be a track, rail, or any other type of sliding system that can be implemented with the first and second sliding door panels 102, 112. The first and second sliding door panels 102, 112 are operable to translate (e.g., slide) along or relative to the support member 120, which allows the first and second sliding door panels to be moved into and away from positions for covering the doorway 12.

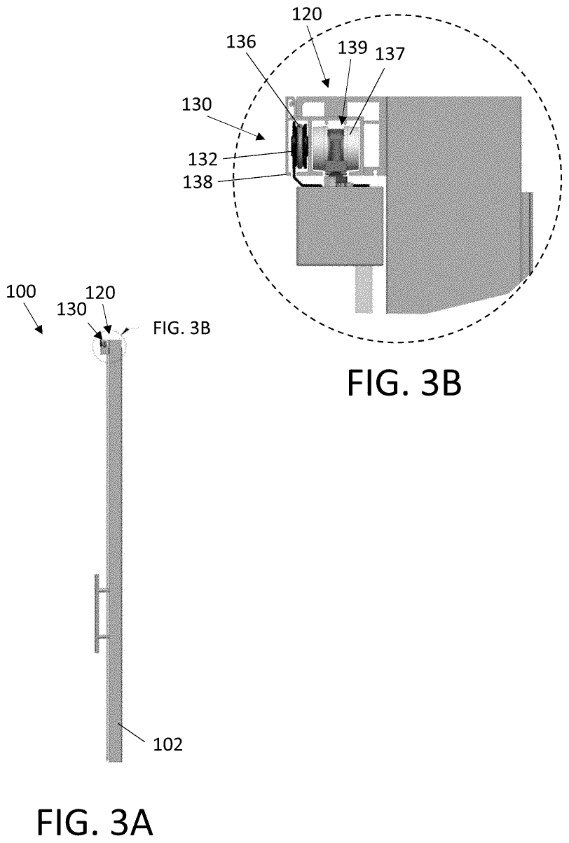

Referring to FIGS. 2A, 2B, 3A, and 3B, the sliding door assembly includes a reciprocal motion assembly 130 that allows the translation of either the first or second sliding door panels 102, 112 to be applied to the other of the first or second sliding door panels 102, 112. The reciprocal motion assembly 130 includes a first portion 132 that is coupled to the first sliding door panel 102 and a second portion 134 that is coupled to the second sliding door panel 112. The reciprocal motion assembly 130 may also include a mechanical transmission member 136 that is coupled to both the first portion 132 and the second portion 134. The mechanical transmission member 136 coordinates the motion from the first portion 132 and translates that motion into motion of the second portion 134 and/or coordinates the motion from the second portion 134 and translates that motion into motion of the first portion 132. In a non-limiting example, the mechanical transmission member 136 may include a cable or plurality of cables that are coupled to the first and second sliding door panels 102, 112 and a pulley system for coordinating the action to the first and second portions 132, 134. It is understood that various other forms of reciprocal motion assemblies may be implemented, including, but not limited to, gear transmission, hydraulics, magnetics, and so forth. The motion transmitted may be a 1:1 ratio, but the mechanical transmission member 136 may be configured to provide and appropriate transmission ratio, including 1:2 or any ratio between 1:1 and 1:2. In this way the reciprocal motion member is operably coupled to the first sliding door panel 102 and the second sliding door panel 112 to translate one of the first or second sliding door panels 102, 112 when another of the first or second sliding door panels 102, 112 is translated along the support member 120.

Referring to FIG. 3B, in some embodiments, the reciprocal motion assembly 130 is concealed within the sliding door assembly 100 and/or the first wall 20 (FIG. 1). For example, when the sliding door assembly 100 is implemented with a wall partition system, the reciprocal motion assembly 130 is coupled to the first and second sliding door panels 102, 112 (FIG. 2A). The reciprocal motion assembly 130 can include a cover 138 to conceal the operating mechanisms (e.g., the first and second portions 132, 134 and the mechanical transmission member 136). In some embodiments, the reciprocal motion assembly 130 is concealed within the profile of the first wall 20 (e.g., within a wall partition system). In other embodiments, portions of the reciprocal motion assembly 130 includes at least some of the components exposed for aesthetic and/or accessibility purposes.

The sliding door panels 102, 112 are may implement any variety of systems for effectuating the sliding motion of the panels. For example, the sliding door panels 102, 112 may include (e.g., coupled to or positioned with) wheels, pulleys, roller bearings, sliding surfaces, and so forth. For example, referring to FIG. 3B, the first and second sliding door panels 102, 112 include roller bearings 137 that are operable to roll relative to a channel 139 within which the roller bearings 137 are housed.

In some embodiments, the sliding door assembly 100 includes a first fixed panel 140 and a second fixed panel 142 (FIGS. 1 and 2A). The fixed panels 140, 142 may be supported by the first wall 20 or in some embodiments may comprise the first wall 20 (e.g., modular wall or divider systems). The first fixed panel 140 is positioned on the first lateral side 16 of the doorway 12 and the second fixed panel 142 is positioned on the second lateral side 18 of the doorway 12. The fixed panels 140, 142 are positioned flanking the doorway 12. In some embodiments, the fixed panels 140, 142 are an integral part of the first wall 20 (e.g., either a portion of the on-site built walls or part of the modular wall system). The sliding door panels 102, 112 are operable to translate into an open configuration such that the first sliding door panel 102 is positioned in front of or behind the first fixed panel 140 and the second sliding door panel 112 is positioned in front of or behind the second fixed panel 142 (e.g., the sliding door panels 102, 112 are out of plane with the fixed panels 140, 142 when in the open configuration). In other embodiments, the first and second sliding door panels 102, 112 are pocket doors, and therefore a space is provided within the profile of the fixed panels 140, 142 or wall 22 within which at least a portion of the sliding door panels 102, 112 are positioned when in the open configuration (e.g., the sliding door panels 102, 112 are in plane with the fixed panels 140, 142 when in the open configuration).

As previously mentioned, the first and second sliding door panels 102, 112 are asymmetric in width. For example, the first sliding door panel 102 has a first width 104 and the second sliding door panel 112 has a second width 114, where the first width 104 of the first sliding door panel 102 is less than the second width 114 of the second sliding door panel 112. As illustrated, the doorway 12 defines the midpoint 24 which is laterally between the fixed side panels 140, 142. When the sliding door panels 102, 112 are in the closed configuration, the second sliding door panel 112 extends beyond the midpoint 24 of the doorway 12 such that it is positioned in both the first area 26 and the second area 28 of the doorway 12 and the first sliding door panel 102 is positioned only in the first area 26 of the doorway 12 (FIG. 1). When the sliding door panels 102, 112 are positioned in the open configuration, the first sliding door panel 102 is positioned in the first area 26 and the second sliding door panel 112 is positioned in the second area 28. Thus, when the sliding door panels 102, 112 are transitioned from the closed to the open configuration, the portion of the second sliding door panel 112 that was positioned in the first area 26 is translated out of the first area 26 and into the second area 28.

When the sliding door panels 102, 112 are in the open configuration, the first sliding door panel 102 with the first width 104 is positioned completely concealed by or within the lateral profile of the first fixed panel 140 (either in plane or out of plane with the first wall 22 or first fixed panel 140). For example, the first sliding door panel 102 is positioned beyond the first lateral side 16 of the door frame 14 (e.g., the first sliding door panel 102 is positioned outside of the doorway 12). The second sliding door panel 112 is positioned partially concealed by or within the lateral profile of the second fixed panel 142 (either in plane or out of plane with the first wall 22). For example, the second sliding door panel 112 is positioned only beyond the second lateral side 18 of the door frame 14 (e.g., the second sliding door panel 112 is positioned extending partially into the doorway 12). By having the asymmetric sliding door panels 102, 112, the fixed panels 140, 142 or portions of the first wall 20 may be symmetrical in width on each side of the doorway 12. This allows the space of the room 10 to be used more efficiently and effectively. For example, furniture may be placed on each side of the doorway 12 without extending into the doorway 12 when the furniture is positioned adjacent to the fixed panels 140, 142 or the first wall 20. Having the fixed panels 140, 142 symmetrical can also be aesthetically more desirable.

As discussed, at least a portion of the second sliding door panel 112 may extend into the doorway 12 when the sliding door panels 102, 112 are positioned in the open configuration. This portion of the second sliding door panel 112 may include a handle 150 with which the user may engage to translate the first and second sliding door panels 102, 112 between the open and closed configurations. By maintaining a portion of the second sliding door panel 112 in the doorway 12 when the sliding door panels 102, 112 are in the open configuration, access to the handle 150 is maintained for the user (e.g., the handle is exposed or not concealed behind the second fixed panel 142). As illustrated in FIG. 1, the handle 150 may be positioned at or near the midpoint 24 of the doorway 12 when the first and second sliding door panels 102, 112 are in the closed position. In one example, the handle 150 is least partially or completely within the second area 28 of the doorway 12. In another example, the handle 150 is least partially or completely within the first area 26 of the doorway 12 (not shown).

Because the sliding door assembly 100 includes the reciprocal motion assembly 130, the first sliding door panel 102 need not include a handle (e.g., is free from any handle). This allows the first sliding door panel 102 to be positioned within the profile of the first fixed panel 140 when in the open configuration. By having the first fixed panel positioned within the profile of the first fixed panel 140 when in the open configuration, the width of unobstructed portions of the doorway is increased. For example, when a single handle is implemented on a sliding door assembly 100, about six inches of extra clearance through the doorway 12 is provided as opposed to an assembly implementing a handle on each sliding door panel. The minimum clearance for a doorway may be a limiting factor in designing office space as there are specific codes to which builders must adhere. Sliding doors also need a specific amount of space to slide within a room in order to clear the doorway to at least a minimum width. The implementation of asymmetric sliding door panels can allow for maximized doorway clearance in a minimal footprint by having the first sliding door panel 102 positioned within the profile of the first fixed panel 140 (e.g., substantially matching) and the second sliding door panel 112 is slightly wider than the second fixed panel 142 such that a portion of the second sliding door panel 112 is exposed when in the open configuration to maintain access to the handle 150. For example, in some embodiments where the length of the first wall 20 can be provided at about six-foot, six-inches wide while maintaining an opening in the doorway 12 when the first and second sliding door panels 102, 112 are in the open configuration that allows for safe clearance through the doorway (e.g., minimum clearance standards for fire safety, building codes, and so forth).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A sliding door assembly comprising:
a first sliding door panel having a first width and positioned on a first side;
a second sliding door panel having a second width that is greater than the first width of the first sliding door panel and positioned on a second side;
at least one support member operable to support the first and second sliding door panels and along which the first and second door panels are operable to translate; and
a reciprocal motion member operably coupled to the first sliding door panel and the second sliding door panel, the reciprocal motion member operable to translate one of the first or second sliding door panels when another of the first or second sliding door panels is translated along the at least one support member.

2. The sliding door assembly of claim 1, further comprising:
a first fixed panel positioned on the first side; and
a second fixed panel positioned on the second side,
wherein the first sliding door panel is concealed by a profile of the first fixed panel when the sliding door assembly is in an open configuration, and
wherein the second sliding door panel is partially concealed by a profile of the first second panel when the sliding door assembly is in the open configuration.

3. The sliding door assembly of claim 2, wherein the second sliding door panel includes a handle, wherein the handle is exposed when the sliding door assembly is in the open configuration.

4. The sliding door assembly of claim 3, wherein the first sliding door panel is free of any handle.

5. A sliding door assembly for limiting and allowing ingress and egress through a doorway defining a lateral midpoint defining a first side and a second side, the sliding door assembly comprising:
a first sliding door panel positioned to cover a portion of the first side of the doorway when the sliding door assembly is in a closed configuration; and
a second sliding door panel positioned to cover the second side and a portion of the first side of the doorway when the sliding door assembly is in the closed configuration.

6. The sliding door assembly of claim 5, wherein the second sliding door panel includes a handle.

7. The sliding door assembly of claim 6, wherein the handle of the second sliding door is positioned on the first side of the doorway when the sliding door assembly is in the closed configuration.

8. The sliding door assembly of claim 7, wherein the first sliding door panel is free of any handle.

9. The sliding door assembly of claim 5, wherein, when the sliding door assembly is in an open configuration, the first sliding door panel is positioned outside of a lateral width of the doorway and the second sliding door panel is positioned partially outside of the lateral width of the doorway and partially inside of the lateral width of the doorway.

10. The sliding door assembly of claim 9, further comprising a reciprocal motion member operably coupled to the first sliding door panel and the second sliding door panel, the reciprocal motion member operable to translate one of the first or second sliding door panels when another of the first or second sliding door panels is translated into or out of the doorway.

11. The sliding door assembly of claim 10, wherein the reciprocal motion member includes a cable and pulley system, the cable being coupled to each of the first and second sliding door panels.

12. The sliding door assembly of claim 10, wherein the reciprocal motion member includes a transmission including gears for transmitting the motion of the first or second sliding door panel to the other.

13. The sliding door assembly of claim 10, wherein the reciprocal motion member includes hydraulics for transmitting motion of the first or second sliding door panel to the other.

14. The sliding door assembly of claim 10, wherein the reciprocal motion member is operable to transmit motion of the first or second sliding door panel to the other in a 1:1 ratio.

15. The sliding door assembly of claim 5, wherein the first and second sliding door panels are pocket doors.

16. A modular wall system, comprising:
a plurality of wall panels forming a room when installed, the plurality of wall panels defining a doorway for ingress and egress, the doorway including a lateral midpoint defining a first side and a second side; and
a sliding door assembly including a first sliding door panel positioned to cover a portion of the first side of the doorway when the sliding door assembly is in a closed configuration and a second sliding door panel positioned to cover the second side and a portion of the first side of the doorway when the sliding door assembly is in the closed configuration.

17. The modular wall system of claim 16, wherein, when the sliding door assembly is in an open configuration, the first sliding door panel is positioned outside of a lateral width of the doorway and the second sliding door panel is positioned partially outside of the lateral width of the doorway and partially inside of the lateral width of the doorway.

18. The modular wall system of claim 17, further comprising a reciprocal motion member operably coupled to the first sliding door panel and the second sliding door panel, the reciprocal motion member operable to translate one of the first or second sliding door panels when another of the first or second sliding door panels is translated into or out of the doorway.

19. The modular wall system of claim 18, wherein the reciprocal motion member includes a cable and pulley system, the cable being coupled to each of the first and second sliding door panels.

20. The modular wall system of claim 17, wherein the plurality of wall panels includes a first fixed panel corresponding to the first sliding panel and a second fixed panel corresponding to the second sliding panel, wherein the first sliding panel is positioned fully within a profile of the first fixed panel when in the open configuration and the second sliding panel is positioned partially within a profile of the second fixed panel when in the open configuration.
